(19) United States
(12) Patent Application Publication
(10) Pub. No.: US 2009/0137411 A1
(43) Pub. Date: May 28, 2009

(54) Methods and biochips for detecting small molecule compounds

(76) Inventors: Yimin Sun, Beijing (CN); Wanli Xing, Beijing (CN); Guoqing Wang, Beijing (CN); Hongwu Du, Beijing (CN); Rong Zhang, Beijing (CN); Yuan Lu, Beijing (CN); Yan Wang, Beijing (CN); Jing Cheng, Beijing (CN)

Correspondence Address: MORRISON & FOERSTER LLP, 12531 HIGH BLUFF DRIVE, SUITE 100, SAN DIEGO, CA, 92130-2040, US

(21) Appl. No.: 10/593,908

(22) PCT Filed: Mar. 28, 2005
(86) PCT No.: PCT/CN05/00387

§ 371 Date: Sep. 6, 2007

(30) Foreign Application Priority Data
Mar. 26, 2004 (CN) 200410029590.7

(51) Int. Cl. C40B 30/04; C40B 40/04; C40B 50/18

(52) U.S. Cl. 506/9; 506/15; 506/32

(57) ABSTRACT

The present invention discloses methods for detection of small molecule compounds and its specific biochips. Biochips of the present invention comprise a solid support and carrier-linked small molecules immobilized onto the solid support. The invention also provides methods and kits for detection of small molecule compounds using the biochips of the invention.

### FIELD OF THE INVENTION

The present invention relates methods of detecting compounds and devices for detecting compounds. More particularly, the present invention relates to methods of detecting small molecule compounds and biochips for detecting small molecule compounds.

### BACKGROUND OF THE INVENTION

Biochip technology is one of the most important advancements in science and technology since mid-nineties. It is a technology crossing biology, electronics, physics, chemistry and computer science. Biochip technology generally includes the following procedures: first, biochips are generated by immobilizing biological molecules such as nucleic acid fragments, peptides and even cells and tissues in some order onto a solid support such as glass slide, silica slide, hydrogel and membrane; the biochip generated is reacted with target molecules in samples; finally, the signal intensities of the biochip are analyzed effectively through the special apparatus such as scanner to analyze the concentration of the target molecules in the sample. Based on the differences of the immobilized molecules, biochips can be classified into gene microarray, protein microarray, cell microarray and tissue microarray. Lab-on-chip developed in recent years is also an important branch of biochip technology.

The two main methods currently used for small molecule detection are physical analysis and immunological analysis. Physical analysis mainly includes spectrum method, chromatography, and combination of these methods. Chromatography detection is mostly used, such as HPLC, GC and TLC. Immunological analysis includes RIA, ELISA, FIA, among which ELISA is mostly used.

Chromatography separation system mainly includes the separated components, fluid phase and stationary phase. The separation principle is based on the distribution coefficiency difference of each component in the two phases. When the two phases move relative to each other, the components are separated by distributing repeatedly between the two phases along the movement of the fluid phase. Chromatography separation has the advantages of high effectiveness, good selectivity and accurate qualitative and quantitative analysis. But it also has some disadvantages such as complicate sample preparation, expensive apparatus and long time detection period.

Immunological analysis such as ELISA of small molecules is a kind of combination technology of immunology, analytical chemistry and synthetic chemistry. There are two ways of using ELISA for detection of small molecules. One way is that the antibody is immobilized and the detection is completed by enzyme-linked small molecule. The other way is that the carrier-linked small molecule is immobilized and the detection is completed by enzyme-linked antibody. ELISA has the advantages of high sensitivity, low detection cost and short time detection period. However, its disadvantage is single-target detection.

### BRIEF SUMMARY OF THE INVENTION

The present invention provides methods and biochips for detecting small molecule compounds.

The invention provides a biochip for detecting a small molecule compound comprising a solid support and a conjugate of a carrier and a small molecule compound, wherein the conjugate is immobilized on a surface of the solid support.

In some embodiments, the small molecule compound has a molecular weight ranging from 1 to 10,000 daltons. In some embodiments, the small molecule compound is a veterinary drug selected from the group consisting of enrofloxacin, furantoin, furacilin, furazolidone, ciprofloxacin, sulfadimidine, sulfamethoxydiazine, sulfamethazine, sulfadimoxinum, sulfamethoxazole, sulfamerazine, sulfamethoxypyridazine, sulfamonomethoxine, sulfaquinoxaline, sulfadiazine, sulfathiazole, chlortetracycyline, clenbuterol, streptomycin, chloramphenicol, norfloxacin, difloxacin, dihydrostreptomycin, tetracycline, oxytetracycyline, digoxin, aflatoxins, kanamycin, mercaptoethanol, penicillins, gentamicin, vancomycin, neomycin, salinomycin, dienestrol, diethylstilbestrol, carbadox, and clopidol. In some embodiments, the small molecule compound is a prohibited substance selected from the group consisting of amphetamine, benzoylecgonine, phencyclindine, theophylline, barbiturate methadone, benzodizepine, morphine, tricyclic antidepressant, gentamicin, digoxin, estradiol, tobramycin.

In some embodiments, the carrier is a protein selected from the group consisting of human serum albumin (HSA), bovine serum albumin (BSA), keyhole limpet hemocyanin (KLH), and ovabumin (OVA).

In some embodiments, a plurality of conjugates are immobilized on the solid support to form a two-dimensional array.

In some embodiments, the biochip further comprises one or more control immobilized on the surface of the solid support, wherein the control is selected from the group consisting of a blank control, a negative control, a sample preparation control, an immobilization control, and a data normalization control. In some embodiments, the biochip comprises a blank control, a negative control, a sample preparation control, an immobilization control, and a data normalization control immobilized on the surface of the solid support.

In some embodiments, the solid support is selected from the group consisting of ceramic, glass, silica, quartz, nylon, plastic, polystyrene, nitrocellulose, and metal.

The invention also provides a method of making a biochip for detecting a small molecule compound, said method comprising: a) linking a small molecule compound to be detected to a carrier to form a conjugate; b) spotting the conjugate onto a chemically modified surface of a solid support; and c) drying the spotted solid support.

The invention also provides a method for detecting a small molecule compound in a sample, said method comprising: a) incubating a biochip described herein with a sample and a binding molecule that specifically binds to the small molecule compound under conditions suitable for specific binding of the binding molecule to the small molecule compound; b) detecting binding of the binding molecule to the small molecule compound in the conjugate immobilized on the surface of the biochip, whereby the presence or absence or the quantity of the small molecule compound in the sample is detected.

In some embodiments, the biochip is incubated in a blocking solution before step a).

In some embodiments, the biochip in step a) is incubated with a mixture of the sample and the binding molecule. In some embodiments, the biochip in step a) is first incubated with the sample and then incubated with the binding molecule. In some embodiments, the biochip in step a) is first incubated with the binding molecule and then incubated with the sample.

In some embodiments, the method further comprises a step of comparing the binding of the binding molecule to the small molecule compound in the conjugate immobilized on the surface of the biochip to binding of the binding molecule to a control immobilized on the surface of the biochip.

In some embodiments, the binding molecule is an antibody or a polymer. In some embodiments, the binding molecule is linked to a label, and binding of the binding molecule to the small molecule compound in the conjugate immobilized on the surface of the biochip is detected by detecting the presence or absence or quantity of the label on the biochip. The label may be a molecule selected from the group consisting of a fluorescent, an enzymatic, a biotin, a radioactive, and a luminescent label.

In some embodiments, the method further comprises a step of incubating the biochip with a secondary antibody that specifically binds to the binding molecule, and the binding of the binding molecule to the small molecule compound in the conjugate immobilized on the surface of the biochip is detected by detecting binding of the secondary antibody. In some embodiments, the secondary antibody is linked to a label, and binding of the secondary antibody to the binding molecule is detected by detecting the presence or absence or quantity of the label on the biochip.

In some embodiments, the method of the invention is used for detecting residual veterinary drug or detecting abuse of prohibited substances.

The invention also provides a kit for use in any of the detection methods described herein. In some embodiments, the kit comprises a biochip described herein and a binding molecule that specifically binds to the small molecule compound. The kit may further comprise instructions for use of detecting small molecule compounds described herein.

### BRIEF DESCRIPTION OF THE DRAWINGS

FIG. 1 shows a biochip reacted with a negative sample in which the residual sulfadimidine, streptomycin and enrofloxacin were lower than the maximum residue limit (MRL).

FIG. 2 shows a biochip reacted with a positive sample in which the residual enrofloxacin was higher than the MRL, but the residual sulfadimidine and streptomycin were lower than the MRL.

FIG. 3 shows a biochip reacted with a positive sample in which the residual sulfadimidine was higher than the MRL, but the residual enrofloxacin and streptomycin were lower than the MRL.

FIG. 4 shows a biochip reacted with a positive sample in which the residual streptomycin was higher than the MRL, but the residual enrofloxacin and sulfadimidine were lower than the MRL.

In FIGS. 1-4, all the positive drugs are labeled with white frame and other spots are the negative drugs and controls which can improve the reliability of results.

FIG. 5 shows a typical appearance and layout of the arrays. A: Schematic diagram showing the glass slide and the polyester framing the reaction chambers above each array. B: Drug layout on the array (each drug/substance is printed in triplicate). C: Image of one of the 9×9 array. PCP, phencyclindine; TCA, tricyclic antidepressants; hCG, human chorionic gonadotropin; LH, luteinizing hormone.

FIG. 6 shows result of analysis for amphetamine on a chip. The gray box indicates the expected binding of an antibody to its counterpart.

FIG. 7 is a graph showing calibration curve for amphetamine measured with the biochip. Calibration curve was produced by using different concentrations (0-1024 ug/L) of each substance added to a drug-free urine. FLU, fluorescence.

### DETAILED DESCRIPTION OF THE INVENTION

The present invention provides methods for detecting small molecule compounds using biochips. The present invention has advantages of both biochip technology and immunological analysis. For example, multi-sample detection may be performed at the same time on one biochip. Because of the biochip technology, many targets may be analyzed simultaneously in only one cycle of detection. The results are more reliable. Every step of the detection cycle may also be effectively controlled by the controls in the biochip to confirm the reliability of the results. Small volume of samples are required. About ten-microlitre sample may be enough for a cycle of detection. Thus, the present invention provides many advantages, such as high throughput and abundant information from biochip technology, and simple operation, fast detection, high sensitivity and low cost from immunological analysis. Through the biochip and method of this invention, many small molecule compounds in a sample can be qualitatively, semi-quantitatively or quantitatively detected simultaneously. The molecular weight of the compounds of this invention may be from 1 to 10,000 daltons.

For clarity of disclosure, and not by way of limitation, the detailed description of the invention is divided into the subsections that follow.

### DEFINITIONS

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, “sample” refers to anything which may contain a target small molecule compound that may be assayed by the present methods, kits and chips. The sample may be a biological sample, such as a biological fluid or a biological tissue. Examples of biological fluids include urine, blood, plasma, serum, saliva, semen, stool, sputum, cerebral spinal fluid, tears, mucus, amniotic fluid or the like. Biological tissues are aggregates of cells, usually of a particular kind together with their intercellular substance that form one of the structural materials of a human, animal, plant, bacterial, fungal or viral structure, including connective, epithelium, muscle and nerve tissues. Examples of biological tissues also include organs, tumors, lymph nodes, arteries and individual cell(s). Biological tissues may be processed to obtain cell suspension samples. The sample may also be a mixture of cells prepared in vitro. The sample may also be a cultured cell suspension. In case of the biological samples, the sample may be crude samples or processed samples that are obtained after various processing or preparation on the original samples. For example, various cell separation methods (e.g., magnetically activated cell sorting) may be applied to separate or enrich target cells from a body fluid sample such as blood.

As used herein, “chip”, “biochip” or “microarray chip” refers to a solid substrate with a plurality of one-, two- or three-dimensional micro structures or micro-scale structures on which certain processes, such as physical, chemical, biological, biophysical or biochemical processes, etc., can be carried out. The micro structures or micro-scale structures such as, channels and wells, can be incorporated into, fabricated on or otherwise attached to the substrate for facilitating physical, biophysical, biological, biochemical, chemical reactions or processes on the chip. The chip may be thin in one dimension and may have various shapes in other dimensions, for example, a rectangle, a circle, an ellipse, or other irregular shapes. The size of the major surface of chips, upon which the processes can be carried out, can vary considerably, e.g., from about 1 mm2 to about 0.25 m2. Preferably, the size of the chips is from about 4 mm2 to about 25 cm2 with a characteristic dimension from about 1 mm to about 5 cm. The chip surfaces may be flat, or not flat. The chips with non-flat surfaces may include channels or wells fabricated on the surfaces.

As used herein, an “antibody” (interchangeably used in plural form) is an immunoglobulin molecule capable of specific binding to a target, such as a small molecule compound, carbohydrate, polynucleotide, lipid, polypeptide, etc., through at least one antigen recognition site, located in the variable region of the immunoglobulin molecule. As used herein, the term encompasses not only intact polyclonal or monoclonal antibodies, but also fragments thereof (such as Fab, Fab′, F(ab′)2, Fv), single chain (ScFv), mutants thereof, fusion proteins comprising an antibody portion, humanized antibodies, chimeric antibodies, diabodies linear antibodies, single chain antibodies, multispecific antibodies (e.g., bispecific antibodies) and any other modified configuration of the immunoglobulin molecule that comprises an antigen recognition site of the required specificity. An antibody includes an antibody of any class, such as IgG, IgA, or IgM (or sub-class thereof), and the antibody need not be of any particular class.

### Biochips for Detecting Small Molecule Compounds

The present invention provides a biochip for detecting a small molecule compound comprising a solid support and a conjugate of a carrier and a small molecule compound, wherein the conjugate is immobilized on a surface of the solid support.

In some embodiments, the biochip comprises a solid support and one type of conjugate. In some embodiments, the biochip comprises a solid support and a plurality of different conjugates.

The invention also provides a method of making a biochip for detecting a small molecule compound, said method comprising: a) linking a small molecule compound to be detected to a carrier to form a conjugate; b) spotting the conjugate onto a chemically-modified surface of a solid support; and c) drying the spotted solid support.

Any small molecule compounds that can be conjugated to a carrier and specifically bind to a binding molecule may be detected using the methods and biochips of the present invention. The small molecule compound of the present invention may have a molecular weight ranging from about 1 to about 10,000, from about 100 to about 5,000, from about 200 to about 2,000 daltons.

In some embodiments, the small molecule compound is a veterinary drug. Exemplary veterinary drugs include, but are not limited to, enrofloxacin, furantoin, furacilin, furazolidone, ciprofloxacin, sulfadimidine, sulfamethoxydiazine, sulfamethazine, sulfadimoxinum, sulfamethoxazole, sulfamerazine, sulfamethoxypyridazine, sulfamonomethoxine, sulfaquinoxaline, sulfadiazine, sulfathiazole, chlortetracycyline, clenbuterol, streptomycin, chloramphenicol, norfloxacin, difloxacin, dihydrostreptomycin, tetracycline, oxytetracycyline, digoxin, aflatoxins, kanamycin, mercaptoethanol, penicillins, gentamicin, vancomycin, neomycin, salinomycin, dienestrol, diethylstilbestrol, carbadox, clopidol. Any one or more of these veterinary drugs may be conjugated to a carrier, and any combination of the conjugate may be immobilized onto a solid support of a biochip.

Other small molecule compounds that can be detected using the biochip described herein includes stimulants, narcotics, anabolic agents, and peptide hormones. In some embodiments, the small molecule compound is a prohibited substance. Exemplary prohibited substances include, but are not limited to, amphetamine, benzoylecgonine, phencyclindine, theophylline, barbiturate methadone, benzodizepine, morphine, tricyclic antidepressant, gentamicin, digoxin, estradiol, tobramycin, amineptine, amiphenazole, bromantan, caffeine, carphedon, cocaine, ephedrines, fencamfamine, mesocarb, pentylentetrazol, pipradol, salbutamol, salmeterol, terbutaline, dextromoramide, diamorphine (heroin), methadone, morphine, pentazocine, pethidine, rostenedione, clostebol, dehydroepiandrosterone (DHEA), fluoxymesterone, metandienone, nandrolone, oxandrolone, stanozolol, testosteronectenbuterot, fenoterol, salbutamol, salmeterol, and terbutaline. Any one or more of these prohibited substances may be conjugated to a carrier, and any combination of the conjugates may be immobilized onto a solid support of a biochip.

The small molecules compound is conjugated to a carrier before being immobilized on the biochip. The small molecule compound may be coupled or linked to the carrier in any ways known in the art. In some embodiments, the small molecule compound is cross-linked to the carrier using one or more crosslinking agents via functional groups on the small molecule compound and the carrier. The functional group on the small molecule and/or the carrier may be modified in order to react with a specific cross-linking agent. Cross-linking agents that may be used include, but not limited to, dicyclohexylcarbodi-imide (DCC), N-hydroxy-succinimide (NHS), 1,1-bis(diazoacetyl)-2-phenylethane, glutaraldehyde, N-hydroxysuccinimide esters (e.g., esters with 4-azidosalicylic acid, homobifunctional imidoesters, disuccinimidyl esters, 3,3′-dithiobis(succinimidylpropionate)), and bifunctional maleimides (e.g., bis-N-maleimido-1,8-octane). Non-covalent linking methods may also be used. In some embodiments, the small molecule compound and the carrier are linked via biotin-streptavidin or biotin-avidin interaction. For example, the small molecule compound may be biotinalized and the carrier protein is linked to a strepavidin molecule. Other methods known in the art can be used to conjugate the small molecule compound to the carrier.

The small molecule compounds are conjugated to carriers before being immobilized onto a biochip. Carriers can be any molecules that are useful for immobilizing the small molecule compounds onto a solid support and presenting the small molecule compounds to a binding molecule. Exemplary carriers include, but are not limited to, proteins, polypeptides, polymers, nucleic acids. For example, serum albumin (SA) (such as human serum albumin (HAS) and bovine serum albumin (BSA)), keyhole limpet hemocyanin (KLH), and ovabumin (OVA), amino acid polymers, immunoglobulins may be used as carriers.

The conjugates may be immobilized onto a surface of a biochip using any methods known in the art. The surface of the biochip may be chemically modified, such as glass slides modified with aldehyde groups. Example 3 describes methods of immobilizing conjugates onto aldehyde-activated glass slides. The conjugates may be spotted onto the surface using any techniques known in the art, such as automated spotting apparatus. After spotting, the biochip may be dried to allow immobilization of the conjugates onto the surface of the biochip.

The biochip may also have one or more controls immobilized on the same surface as the conjugates. Exemplary controls are blank controls, negative controls, sample preparation controls, immobilization controls, and data normalization controls. One or more conjugates of the small molecule compounds and the carriers may be immobilized onto the biochips to form a two-dimension array, for example, a 9×9 array, 12×12 array, and 15×15 array. One or more arrays may be arranged on one biochip, and one or more samples can be tested using one biochip.

The sample volume used for testing may be less than about any of 1 ml, 0.5 ml, 0.25 ml., 0.1 ml, 0.05 ml, and 0.01 ml.

In some embodiments, the solid support of the biochip comprises a surface selected from the group consisting of a ceramic, a glass, a silica, a quartz, a nylon, a plastic, a polystyrene, a nitrocellulose, and a metal.

### Methods for Detecting Small Molecule Compounds

The present invention uses a competitive immunoassay. The invention provides a method for detecting a small molecule compound in a sample, said method comprising: a) incubating a biochip described herein with a sample and a binding molecule that specifically binds to the small molecule compound under conditions suitable for specific binding of the binding molecule to the small molecule compound; b) detecting binding of the binding molecule to the small molecule compound in the conjugate immobilized on the surface of the biochip, whereby the presence or absence or the quantity of the small molecule compound in the sample is detected.

The biochip may be first incubated in a blocking solution for blocking nonspecific binding, for example, blocking the non-spotted area on the biochip. Any blocking solution used for immunoassay may be used. For example, phosphate-buffered saline (PBS), pH 7.4 containing serum or BSA may be used. After blocking, the biochip may be washed before the next step.

The biochip may be incubated with a mixture of the sample to be tested and the binding molecule. The biochip may also be incubated first with the sample and followed by incubation with the binding molecule, or incubated first with the binding molecule and followed by incubation with the sample.

Any binding molecule that specifically binds to the small molecule compound may be used, for example, antibodies, polypeptides, and polymers. As used herein, a binding molecule specifically binds to an epitope or a small molecule compound is a term well understood in the art, and methods to determine such specific binding are also well known in the art. A molecule is said to exhibit “specific binding” if it reacts or associates more frequently, more rapidly, with greater duration and/or with greater affinity with a particular substance than it does with alternative substances. Since different molecules may have The same or similar epitope, a binding molecule may cross-react with more than one compounds. Specific binding used herein includes specific binding to an epitope or structurally related compounds. Binding molecules that cross-react with more than one structurally related small molecules may be used to detect these small molecules, and the binding of such a binding molecule to the biochip may indicate the presence and/or quantity of any of these small molecules that the binding molecule cross-reacts with.

After the incubation, the biochip may be washed before binding detection.

Binding of the binding molecules to the small molecules in the conjugates immobilized on the biochips can be detected using any methods known in the art. In some embodiments, the binding molecules (such as, antibodies and polymers) are linked to a label, such as, a fluorescence, an enzyme, a biotin, a radioisotope, and a luminescence. The binding of the binding molecules to the biochip are detected by detecting the presence or absence, and/or quantity of the label on the biochip. Any labels and methods known in the art for detecting the labels may be used. Since this is a competitive immunoassay design, the absence or lower level of the signal indicates the presence and higher quantity of the small molecule compound in the sample tested.

Binding of the binding molecule to the biochip may also be detected using a secondary binding molecule which is linked to a label. Any label known in the art and described herein may be used. After incubation with the binding molecule and the sample, the biochip is further incubated with the secondary binding molecule which specifically binds to the binding molecule. In some embodiments, the secondary binding molecule is an antibody.

### Kits for Detecting Small Molecule Compounds

The present invention also provides a kit for detecting a small molecule compound in a sample, said kit comprising one or more biochips described herein and one or more binding molecules that specifically bind to the small molecule compounds. The kits may include one or more containers and may further comprise instructions for use in accordance with any of the methods described herein.

The instructions supplied in the kits are typically written instructions on a label or package insert (e.g., a paper sheet included in the kit), but machine-readable instructions (e.g., instructions carried on a magnetic or optical storage disk) are also acceptable. The label or packaging insert may indicate that the biochip and the binding molecule are used for detecting small molecule compounds, such as veterinary drugs, or prohibited substances. The kits of this invention may be in suitable packaging. Suitable packaging includes, but is not limited to, vials, bottles, jars, flexible packaging (e.g., sealed Mylar or plastic bags), and the like. Kits may optionally provide additional components, such as blocking solution and washing solution, control samples, buffers and interpretive information.

### EXAMPLES

### Example 1

### Preparation of Biochips for Residual Veterinary Drugs Detection

The biochips were prepared in four steps as described below.

Step 1. Spotting solutions were prepared by dissolving each of BSA-linked enrofloxacin, OVA-linked sulfadimidine, OVA-linked streptomycin, negative control, sample preparation control, immobilization control, and data normalization control in spotting buffer (40% glycerol, 60% PBS) at protein concentration of 1.0 mg/mL. Each potting solution was then transferred into the 384-hole plate for spotting onto a biochip.

The three veterinary drugs were conjugated to the carrier proteins as described below:

Conjugation of enrofloxacin and BSA: 1) 1200 mg hydrochloric enrofloxacin was added into 1.0 ml pure water. The pH of solution was adjusted to pH 6.0 with 2 mol/L NaOH. The solution was incubated at 4° C. for 30 minutes. Then dicyclohexylcarbodi-imide (DCC) and N-hydroxy-succinimide (NHS) (both from Sigma) solution were added, and reaction was allowed for 30 minutes. 2) 1.0 g BSA was added into 0.2 mol/L phosphate buffer (pH 7.2), mixed. The BSA solution was then slowly added into the solution prepared in step 1), and the mixed solution was incubated at 4° C. overnight to form the conjugate. 3) The BSA and enrofloxacin solution prepared in step 2) was dialyzed against phosphate buffer for 5 days. The phosphate buffer was changed at least 12 times. The dialyzed conjugate solution was stored at −20° C.

Conjugation of sulfadimidine and ovabumin (OVA): 1) 500 mg sulfadimidine was added into 500 ul DMF. Then 50% glutaradehyde solution was added for activation, and solution was incubated at 4° C. for 50 minutes. Na2CO3 (0.2 M) solution was added to adjust pH in the range of 8-9, and the reaction was allowed for another hour. 2) 1.0 g OVA was dissolved in phosphate buffer (pH 7.2) to 0.2 mol/L, and OVA solution was then added into the solution prepared in step 1) and then incubated at 4° C. overnight to form the conjugate. 3) The solution prepared in step 2) was dialysed against phosphate buffer for 5 days The phosphate buffer was changed at least 12 times. The dialyzed conjugate solution was stored at −20° C.

Conjugate of streptomycin and OVA: 1) 500 mg vitriolic streptomycin was added into 0.5 ml pure water. Then 2.0 g carboxylmethyl hydroxylamine was added into streptomycin solution and solution was incubated at room temperature for 3 hours. Na2SO4 solution (1M) was added into the solution and reaction was allowed for additional 1 hour. After checking the pH of the solution which was at pH 7.5, 600 mg of DCC was added into the solution and incubated at 4° C. for 2 hours. 2) 1.0 g OVA was added into 0.2 mol/L phosphate buffer (pH 7.2). The OVA solution was then added into the solution prepared in step 1), and the mixed solution was incubated at 4° C. overnight to form conjugate. 3) The solution containing the conjugate prepared in step 2) was dialysed with phosphate buffer for 5 days. The phosphate buffer was changed at least 12 times. The conjugate solution was stored at −20° C.

Step 2. The above spotting solutions were distributed in some order onto the chemically modified glass chips by automated spotting apparatus. Each chip included 10 arrays (5 rows×2 columns) and each array included 36 sample spots (6 rows×6 columns) in which the interval between two spots was 400 um. Each array was an isolated reaction chamber.

Step 3. After spotting, the chips were dried with vacuum machine.

Step 4. Once dried, the chips were vacuum-packed and stored at 4° C. Chips prepared as described above can be used to detect enrofloxacin, sulfimidine and streptomycin in qualitative analysis, semi-quantitative analysis and quantitative analysis.

### Example 2

### Detection of Residual Veterinary Drug with Biochips

Samples containing residual enrofloxacin, sulfimidine or streptomycin were tested as described below:

1. Blocking: The biochip prepared as described in Example 1 was blocked with 10% goat serum in 37° C. for 30 minutes.

2. Cleaning and drying: The biochip was then washed in the washing cassette with PBST (PBS containing 0.5% Tween-20) for 5 minutes with agitation, then was centrifuged in 1000 rpm for 1 min in order to dry the chip.

3. The first antibody reaction: The sample to be tested was mixed with an antibody that specifically binds to enrofloxacin, an antibody that specifically binds to sulfimidine, and an antibody that specifically binds to streptomycin (anti-streptomycin antibody was obtained from Beijing Wanger Biotech, Ltd.) with each antibody at 1 mg/ml concentration. Twenty ul of the mixture of the sample and antibodies were added into the reaction and reaction was allowed for 30 min at 37° C.

4. The second antibody reaction: The chip was washed and dried as described in step 2. Then, 20 ul goat-anti-mouse IgG labeled with fluorescence was added into the reaction chamber at a concentration of 1 ug/ml. The chip was incubated at 37° C. for 30 minutes.

5. Chip scan and data analysis: The chip was then washed and dried as described in step 2. The chip was then scanned and the data were analyzed. The results are shown in FIGS. 1-4. Since competitive immunoassay was used, the lower signal spot indicates higher level of residual veterinary drug present in the sample tested.

The sensitivity of the detection system for detecting small molecule compounds of the present invention meets the technical target and maximum residual level (MRL) allowed by Chinese government. The sensitivity and linear range was compared to the MRL in Table 1 below.

TABLE 1
Comparison of sensitivity and linear range
of the detection system to MRL.

| | Sensitivity (ng/g) | Linear range (ng/g) | MRL (ng/g) |
|---|---|---|---|
| Enrofolxacin | 1 | 1-50 | 100 |
| Sulfadimidine | 0.5 | 0.5-20 | 25 |
| Streptomycin | 5 | 5-200 | 200 |

Note: MRL showed in the table was the minimum of MRLs for various type of samples.

Using the system described herein, the sample to be tested may be diluted because the sensitivity of system is much higher than the MRL.

The concentrations of residual veterinary drugs in FIGS. 1-4 are shown in Table 2 below.

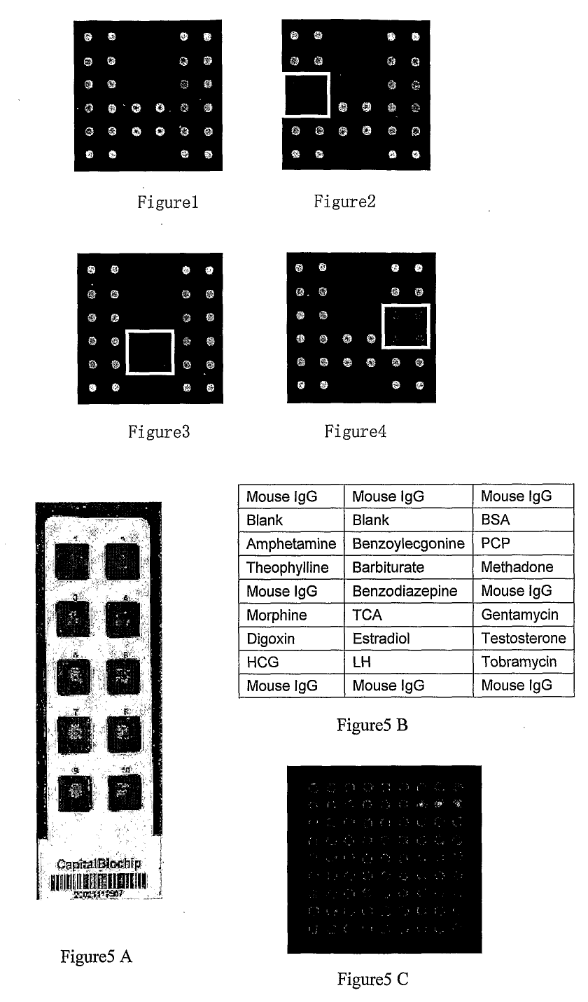

TABLE 2
The residual veterinary drugs in FIGS. 1-4.

| | Enrofloxacin (ng/g) | Sulfadimidine (ng/g) | Streptomycin (ng/g) |
|---|---|---|---|
| FIG. 1 | 0 | 0 | 0 |
| FIG. 2 | 200 | 0 | 0 |
| FIG. 3 | 0 | 50 | 0 |
| FIG. 4 | 0 | 0 | 400 |

### Example 3

### Detection of Prohibited Substances with Biochips

Sample collection. Urine samples were collected and stored at −20° C. Positive control and negative control urine samples were also collected. Details of sample collection are described in Du et al., Clinical Chemistry 51:368-375 (2005).

Preparation of chip substrates. Glass slides chemically modified with aldehyde groups were used as the substrates to covalently bind BSA-conjugated molecules at the designated locations. The slides were cleaned with 100 g/L chromic acid for 6 h, followed by rinsing with deionized water. Slides were then dipped into a 2 mol/L sodium hydroxide solution and then 4 mol/L hydrochloric acid, each for 30 min, followed by rinsing with deionized water and then drying under stream of nitrogen. Cleaned slides were silanized for 8 using 3-glycidoxypropytrimethoxysilane in ethanol (40 mL/L). The glass surface was washed with toluene, acetone, and deionized water, after which the slides were dipped in 4 mol/L hydrochloric acid again for 30 min and then immersed into 50 mmol/L NaIO4 for 1 h to complete the preparation process. The contact angles of the aldehyde-activated slides were measured by use of a contact angle system (Model OCA; DataPhysics Instruments GmbH) for quality-control purposes. Slides were stored in a desiccated box at room temperature for a maximum of 3 months.

Printing of chips. Ten 9×9 arrays of BSA-conjugated drugs were printed on each slide. For a peptide hormone, the peptide was printed directly. On each slide, one sample can be tested on one 9×9 array for a variety of analytes, and up to 10 samples can be analyzed in parallel on one chip. A contact printing robot (PixSys 5500; Cartesian Technologies) with a stealth microspotting pin (Model SMP3; TeleChem International) was used to print the chips on the aldehyde-activated slides. The concentration of each printed protein (drug-BSA) was 500 mg/L in 400 mL/L glycerol or Protein Printing Buffer (TeleChem International). The drug-BSA conjugate was reacted on the chip for 6 h in a humidified chamber. The slide was then stored at room temperature for up to 1 month.

Immunoassay procedures. A competitive immunoassay design was used to test the 16 WADA-prohibited substances on the chips. A molded polyester frame was attached to the substrate to partition 10 arrays on the chip surface (FIG. 5A). This chip consisted of 16 different drug-BSA conjugates and 11 positive or negative controls to form a 9×9 array. Each material was printed in triplicate (FIGS. 5B and 5C). The chips were immersed in blocking solution (a 1:10 dilution of sheep serum in phosphate-buffered saline (PBS), pH 7.4) for 30 min at room temperature and then rinsed three times with PBS containing 0.5 mL/L Tween 20, pH 7.4 (PBS-Tween A). A mixture of the anti-drug mouse monoclonal antibodies (obtained from Fitzgerald Industries International, Inc. and Aviva Antibody Corporation) and a urine sample containing the drug was then applied to the gridded reaction chamber formed by the polyester frame covering the surface of the chip. The chip was then maintained at 37° C. in a humidified chamber for 30 min. The chip was then rinsed 3 times with PBS-Tween A, and the secondary antibody (Cy3-labeled goat anti-mouse IgG) was applied to the chip and incubated at 37° C. for 30 min. The chip was then washed again and scanned for the presence of bound Cy3-labeled secondary antibody by use of a laser confocal scanner (GenePix 4000B; Axon Instruments) or a charge-coupled device-based scanner (EcoScan-100; CapitalBio Corporation). The analog fluorescent signal was converted to digital signal by data analysis software (GenePix Pro 4.0; Axon Instruments). The results obtained from the chip were later compared with those obtained by gas chromatography-mass spectrometry (GC-MS) at China Doping Control Center (CDCC).

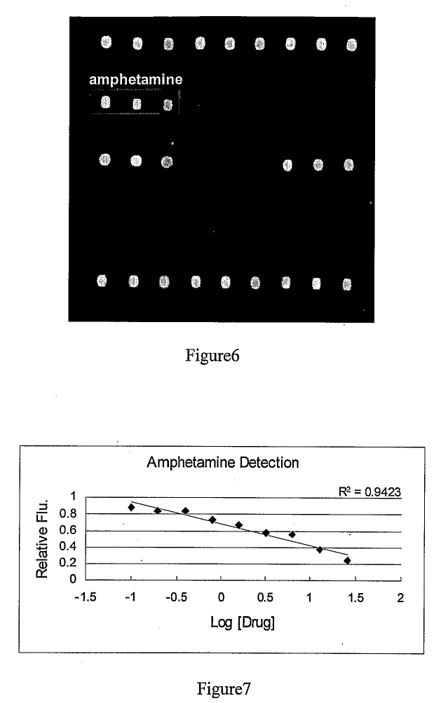

Prohibited substances detected on chips. An example of an image of the chip obtained with a sample negative for amphetamine is shown in FIG. 6. Amphetamine-BSA conjugate was arrayed in triplicate on the aldehyde-activated chip (boxed area in FIG. 6. As expected, the three test spots for each drug bound the anti-drug antibody in a sample negative for that drug and then the bound Cy3-labeled secondary antibody to give a fluorescent signal. In each case, all of the mouse IgG control spots (upper and low rows of nine spots and the two central groups of three spots) were positive, as would be expected from reaction of the immobilized mouse IgG control with the goat anti-mouse conjugate used in the assay.

Influence of different matrices on the fluorescence signal on chips. The potential effect on the fluorescent signal of different samples and solutions, such as urine, water, or PBS, was evaluated. Different solutions could dramatically affect the signals for certain tested substances were found. A significant signal decrease for steroids when the solution was changed from PBS to urine was noticed. This may be attributable to the binding of some endogenous steroid interferents with the corresponding antibodies. Most of the exogenous drugs had a comparable ratio of PBS to blank urine, commonly <1.50. But certain analytes, such as amphetamine, generated an exceptionally high ratio of about 2.50. The assay was repeated in a 96-well plate and all exogenous analytes containing amphetamine had a low PBS-to-blank urine ratio of 1.13-1.18. This suggests that some nondoping substances in human urine may have interfered with the interaction of amphetamine and its antibody.

Detection limit and cutoff value. In principle, the fluorescent signal at the corresponding location is decreased when a tested substance is present in the sample. Within the linear measurement range, the decrease in fluorescent signal was proportional to the amount of drug in the sample. This method can therefore be used for both qualitative and quantitative determination of the presence of substances in a sample. A calibration curve for amphetamine measured with use the biochip is shown in FIG. 7. Calibration curves for other nine prohibited substances are available at http://www.clinchem.org/content/vol51/issue2. The detection limit is defined as the lowest concentration of an analyte that can be detected by the chip. This concentration corresponds to a signal that is 3 SD lower than the mean of the negative control and ranged from 0.2 ug/L for morphine to 19 ug/L for methadone. The detection limit and the cutoff values (the 50% inhibitory concentration) for the 10 drugs are summarized in Table 3 below.

TABLE 3
Detection limits and cutoff values for some representative drugs.

| Substances tested | Detection limit, ug/L | Cutoff value, ug/L |
|---|---|---|
| Morphine | 0.2 | 1.7 |
| Testosterone | 0.4 | 0.6 |
| Estradiol | 0.6 | 1.5 |
| Digoxin | 1.0 | 2.8 |
| Barbiturate | 1.1 | 1.5 |
| Gentamicin | 1.1 | 2.5 |
| Amphetamine | 2.0 | 5.2 |
| Methamphetamine | 3.1 | 4.0 |
| Benzodiazepine | 5.5 | 60.2 |
| Methadone | 19.0 | 71.9 |

Assay precision. In the precision studies, standard samples, including 200 blank urines confirmed by the doping-control-analysis China Doping Control Center (CDCC), were repeatedly analyzed (n=300) by five technicians using different batches of chips The between-batch CV for all analysis was 16%, and the within-batch CV was 13%. See Table 4 of Du et al., Clinical Chemistry 51:368-375 (2005) for each drug.

Qualitative analysis. In a typical screening procedure, urines collected from 141 Chinese gymnastic athletes were tested for prohibited substances for qualitative analysis. Among eight specimens, five specimens were shown positive for morphine, one shown positive for dihydrocodeine, one positive for pethidine, and one shown negative for substances tested. Cross-reactivity with the anti-morphine antibodies for samples containing dihydrocodeine and pethidine was detected. The mean (SD) morphine signal was 0.429 (0.12), and the critical value (used in significance testing, which is the value that a test statistic must exceed for the null hypothesis to be rejected) was 0.232 (P<0.05), which is equivalent to 1.7 ug/L morphine. The sample would be positive for morphine if the measured signal was below the critical value. All positive samples were confirmed by gas chromatography-mass spectrometry (GC-MS) at CDCC.

Quantitative analysis. In addition to serving as a qualitative screening tool for large numbers of sample, the chip can also be used for quantitative analysis. Six replicate tests from samples from four methamphetamine drug abusers were performed using the chips and GC-MS method. The correlation coefficient (r2) for the chip and GC-MS results was 0.991, indicating the comparability of the results obtained by these two methods for quantifying methamphetamine in urine.

The above examples are included for illustrative purposes only and are not intended to limit the scope of the invention. Many variations to those described above are possible. Since modifications and variations to the examples described above will be apparent to those of skill in this art, it is intended that this invention be limited only by the scope of the appended claims.

1. A biochip for detecting a small molecule compound comprising a solid support and a conjugate of a carrier and a small molecule compound, wherein the conjugate is immobilized on a surface of the solid support.

2. The biochip of claim 1, wherein the small molecule compound has a molecular weight ranging from 1 to 10,000 daltons.

3. The biochip of claim 1, wherein a plurality of conjugates are immobilized on the solid support to form a two-dimensional array.

4. The biochip of claim 1, wherein the small molecule compound is a veterinary drug selected from the group consisting of enrofloxacin, furantoin, furacilin, furazolidone, ciprofloxacin, sulfadimidine, sulfamethoxydiazine, sulfamethazine, sulfadimoxinum, sulfamethoxazole, sulfamerazine, sulfamethoxypyridazine, sulfamonomethoxine, sulfaquinoxaline, sulfadiazine, sulfathiazole, chlortetracycyline, clenbuterol, streptomycin, chloramphenicol, norfloxacin, difloxacin, dihydrostreptomycin, tetracycline, oxytetracycyline, digoxin, aflatoxins, kanamycin, mercaptoethanol, penicillins, gentamicin, vancomycin, neomycin, salinomycin, dienestrol, diethylstilbestrol, carbadox, and clopidol.

5. The biochip of claim 1, wherein the small molecule compound is a prohibited substance selected from the group consisting of amphetamine, benzoylecgonine, phencyclindine, theophylline, barbiturate methadone, benzodizepine, morphine, tricyclic antidepressant, gentamicin, digoxin, estradiol, tobramycin.

6. The biochip of claim 1, wherein the carrier is a protein selected from the group consisting of human serum albumin (HSA), bovine serum albumin (BSA), keyhole limpet hemocyanin (KLH), and ovabumin (OVA).

7. The biochip of claim 1, further comprising a control immobilized on the surface of the solid support, wherein the control is selected from the group consisting of a blank control, a negative control, a sample preparation control, an immobilization control, and a data normalization control.

8. The biochip of claim 1, further comprising a blank control, a negative control, a sample preparation control, an immobilization control, and a data normalization control immobilized on the surface of the solid support.

9. The biochip of claim 1, wherein the solid support is selected from the group consisting of ceramic, glass, silica, quartz, nylon, plastic, polystyrene, nitrocellulose, and metal.

10. A method of making a biochip for detecting a small molecule compound, said method comprising:
linking a small molecule compound to be detected to a carrier to form a conjugate;
spotting the conjugate onto a chemically modified surface of a solid support; and
drying the spotted solid support.

11. A method for detecting a small molecule compound in a sample, said method comprising:
incubating the biochip of claim 1 with a sample and a binding molecule that specifically binds to the small molecule compound under conditions suitable for specific binding of the binding molecule to the small molecule compound;
detecting binding of the binding molecule to the small molecule compound in the conjugate immobilized on the surface of the biochip, whereby the presence or absence or the quantity of the small molecule compound in the sample is detected.

12. The method of claim 11, wherein the biochip is incubated in a blocking solution before step a).

13. The method of claim 11, wherein the biochip in step a) is incubated with a mixture of the sample and the binding molecule.

14. The method of claim 11, wherein the biochip in step a) is first incubated with the sample and then incubated with the binding molecule.

15. The method of claim 11, wherein the biochip in step a) is first incubated with the binding molecule and then incubated with the sample.

16. The method of claim 11, further comprising a step of comparing the binding of the binding molecule to the small molecule compound in the conjugate immobilized on the surface of the biochip to binding of the binding molecule to a control immobilized on the surface of the biochip.

17. The method of claim 16, wherein the control is selected from the group consisting of a blank control, a negative control, a sample preparation control, an immobilization control, and a data normalization control.

18. The method of claim 11, wherein the binding molecule is an antibody or a polymer.

19. The method of claim 11, wherein the binding molecule is linked to a label, and binding of the binding molecule to the small molecule compound in the conjugate immobilized on the surface of the biochip is detected by detecting the presence or absence or quantity of the label on the biochip.

20. The method of claim 19, wherein the label is a molecule selected from the group consisting of a fluorescent, an enzymatic, a biotin, a radioactive, and a luminescent label.

21. The method of claim 11, said method further comprises a step of incubating the biochip with a secondary antibody that specifically binds to the binding molecule, and the binding of the binding molecule to the small molecule compound in the conjugate immobilized on the surface of the biochip is detected by detecting binding of the secondary antibody.

22. The method of claim 21, wherein the secondary antibody is linked to a label, and binding of the secondary antibody to the binding molecule is detected by detecting the presence or absence or quantity of the label on the biochip.

23. The method of claim 11, wherein the method is used for detecting residual veterinary drug in farm animals.

24. The method of claim 11, wherein the method is used for doping agents testing.

25. A kit for detecting a small molecule compound in a sample, said kit comprising a biochip and a binding molecule that specifically binds to the small molecule compound, wherein the biochip comprises a solid support and a conjugate of a carrier and a small molecule compound, wherein the conjugate is immobilized on a surface of the solid support.
